(19) United States
(12) Patent Application Publication
(10) Pub. No.: US 2004/0177306 A1
(43) Pub. Date: Sep. 9, 2004

(54) Transmission device and transmission method

(76) Inventor: Toshiaki Hiraki, Kanagawa (JP)

Correspondence Address: STEVENS DAVIS MILLER & MOSHER, LLP, 1615 L STREET, NW, SUITE 850, WASHINGTON, DC, 20036, US

(21) Appl. No.: 10/480,822

(22) PCT Filed: Apr. 24, 2003
(86) PCT No.: PCT/JP03/05229

(30) Foreign Application Priority Data
Apr. 26, 2002 (JP) 2002-125489

(51) Int. Cl. H04L 1/18; G08C 25/02

(52) U.S. Cl. 714/748

(57) ABSTRACT

A control section 106 receives ACK and NACK sent from a receiving apparatus 150, manages a frame number and the number of transmissions, and controls an interleave pattern deciding section 107 based on these. The interleave pattern deciding section 107 decides an interleave pattern to equalize the frequency with which the respective interleave patterns are applied at the time of retransmitting the same frame data based on control of the control section 106. An interleaver 108 interleaves frame data with the decided interleave pattern. This makes it possible to equalize likelihood of the signal input to a decoder of the receiving apparatus and improve error correction ability of the decoder.

### TECHNICAL FIELD

The present invention relates to a transmitting apparatus and transmitting method using a HARQ (Hybrid Automatic Repeat Request) scheme.

### BACKGROUND ART

The HARQ scheme is a scheme in which error correction coding (particularly, turbo coding) and automatic repeat control are combined to implement data communications with high reliability and high efficiency and this is known as being extremely effective in mobile radio communications under phasing environment. The HARQ scheme has the so-called type 1 to type 3. The following will briefly explain each type.

In the HARQ scheme of type 1, a transmitting side performs error detection coding and error correction coding in advance to configure a frame in a form including information bits and parity bits, and a receiving side combines previously transmitted information bits with parity bits and performs error correction and error detection, and sends a repeat request when an error is detected. This is the scheme that these steps are repeated until no error is detected.

The HARQ scheme of type 2 is a scheme in which the transmitting side configures a transmission frame with information bits and transmits parity bits, which are not previously transmitted, on a priority basis when a repeat request is sent from the receiving side, and combines them with previously transmitted information bits to perform error correction.

The HARQ scheme of type 3 is a scheme in which the transmitting side configures a transmission frame with information bits and parity bits and transmits a parity bit being different from the previously transmitted parity bit when a repeat request is sent from the receiving side, and combines the previously transmitted information bit with the parity bit to perform error correction.

In the type 2 and type 3, when an error is detected in the frame received by the receiving side, the transmitting side transmits another framed data in a block where the error was detected, and decodes both data retransmitted by the receiving side and data where the error was previously detected. This enables to process data as a code whose coding rate changes according to the number of retransmissions, so that correction ability increases every time when the number of retransmissions increases.

As a method for transmitting frame data at a retransmitting time, a transmitting method using a transmission pattern being different for each retransmission is known. Since a signal point is easily influenced by a propagation path depending on the placement position of the signal point, a received signal point is shifted from an ideal signal point to cause an error in determination in some cases, so that reception accuracy of each signal point is not fixed. For this reason, by transmission using a transmission pattern being different for each retransmission, one signal point is placed at a signal point with high reception accuracy and placed at a signal point with low reception accuracy to attain an equal placement, so that likelihood of a signal input to a decoder is equalized every time when the number of retransmissions increases. This confirms that performance of the decoder is improved. This method can be used together with previously explained HARQ. Here, the transmission patterns include the interleave patterns and mapping patterns at a modulating time.

An explanation will be given of a case in which HARQ (type 2 or type 3) and the transmitting method using the interleave pattern being different for each retransmission are used. FIG. 1 is a view explaining a conventional interleave pattern deciding method. In this figure, frame data n-1 and n-2 are those that are obtained by block information bits into a plurality of blocks to code an information sequence of block number n, thereafter framing into two frames (n-1 and n-2 are referred to as frame number). It is assumed that four types of interleave patterns can be used. When the frame data is transmitted to the receiving side from the transmitting side, the receiving side detects an error in a decoding result of block n and transmits NACK that requests retransmission. The transmitting side that received NACK changes an interleave pattern every time when the number of transmissions increases, and transmits frame data. In FIG. 1, frame data of block n is repeatedly transmitted nine times. More specifically, the transmitting apparatus transmits frame data n-1 of a first transmission with an interleave pattern 1, and receives NACK when an error is detected by the receiving side. The transmitting apparatus that received NACK transmits frame data n-2 of a second transmission with an interleave pattern 2. The transmitting apparatus that continuously received NACK transmits frame data n-1 of a third transmission with an interleave pattern 3, and transmits frame data n-2 of a fourth transmission with an interleave pattern 4. At a fifth transmission and afterward, the interleave patterns 1 to 4 are repeated similarly.

In this way, the frame data of the same block is repeatedly transmitted, so that a coding rate decreases with an increase in the number of transmissions. Moreover, every time when transmission is repeated, the interleave pattern changes, so that likelihood of the signal input to the decoder is equalized and error correction ability is improved. This makes it possible to prevent the number of retransmissions from suddenly increasing by deterioration in the characteristic of a communication path.

However, in the aforementioned conventional technique, there is a case in which all transmission patterns cannot be applied to one frame data. Referring to FIG. 1 again, during the time up to a ninth transmission, frame data n-1 is applied to only interleave patterns 1 and 3, and frame data n-2 is applied to only interleave patterns 2 and 4. Namely, only two of four interleave patterns are applied to one frame data, and there is a possibility that an error will be repeatedly detected in a specific signal at the receiving side as compared with a case in which all four patterns are applied, so that it cannot be said that this is effective in terms of the equalization of the likelihood of the signal input to the decoder.

### DISCLOSURE OF INVENTION

An object of the present invention is to provide a transmitting apparatus and transmitting method that efficiently equalizes likelihood of a signal input to a decoder of a receiving apparatus to improve error correction ability of a decoder.

The above object can be attained by deciding a transmission pattern to equalize the frequency with which a plurality of transmission patterns are applied to the same frame data when the transmitting apparatus repeatedly receives NACK indicating a repeat request to retransmit the same frame data repeatedly.

### BRIEF DESCRIPTION OF DRAWINGS

FIG. 1 is a view explaining a conventional interleave pattern deciding method;

FIG. 2 is a block diagram illustrating the configuration of a transmitting apparatus and that of a receiving apparatus according to Embodiment 1 of the present invention;

FIG. 3 is a view explaining an interleave pattern deciding method according to Embodiment 1 of the present invention;

FIG. 4A is a view explaining the order of mapping one signal point of 16 QAM;

FIG. 4B is a view explaining the order of mapping one signal point of 16 QAM;

FIG. 4C is a view explaining the order of mapping one signal point of 16 QAM;

FIG. 4D is a view explaining the order of mapping one signal point of 16 QAM;

FIG. 5 is a block diagram illustrating the configuration of a transmitting apparatus and that of a receiving apparatus according to Embodiment 2 of the present invention; and

FIG. 6 is a view explaining a mapping pattern deciding method according to Embodiment 2 of the present invention.

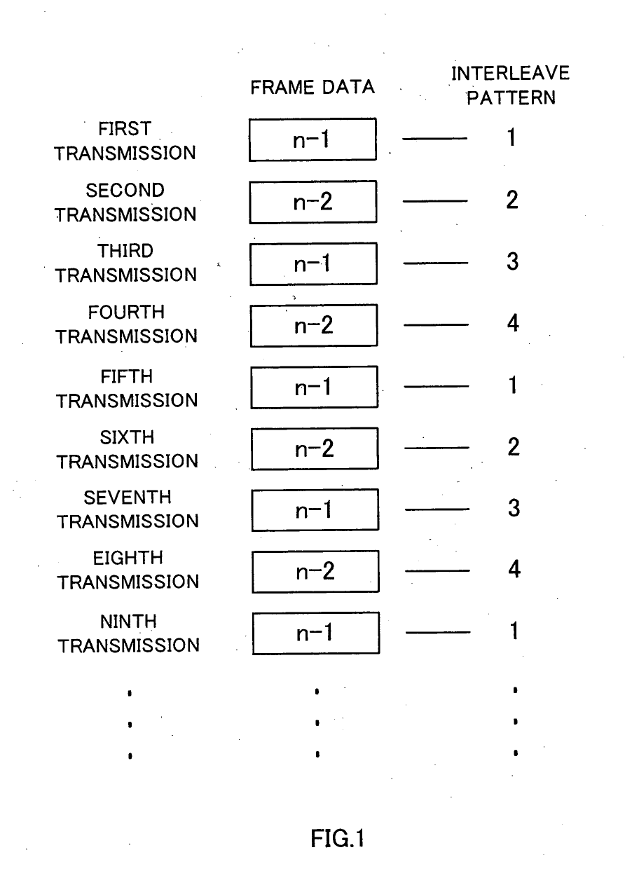

### BEST MODE FOR CARRYING OUT THE INVENTION

Embodiments of the present invention will be explained with reference to the drawings.

(Embodiment 1)

This embodiment explains a case in which an interleave pattern is used as a transmission pattern.

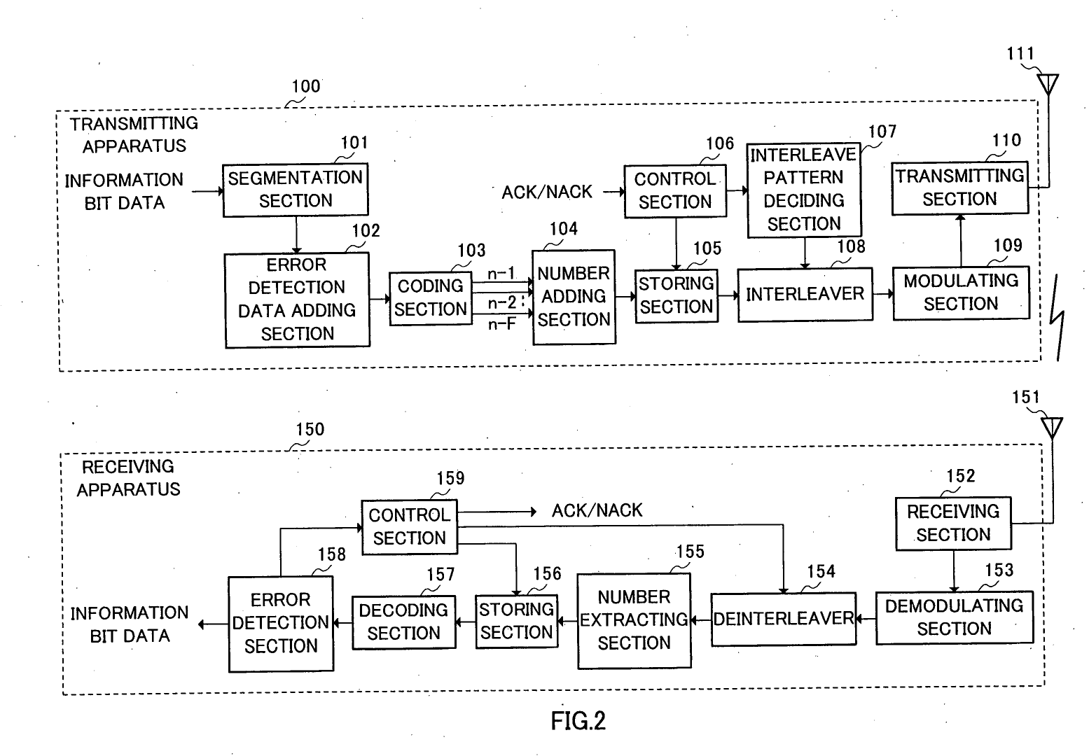

FIG. 2 is a block diagram illustrating the configuration of a transmitting apparatus and that of a receiving apparatus according to Embodiment 1 of the present invention. In this figure, data transmission is performed between a transmitting apparatus 100 and a receiving apparatus 150. The configuration of the transmitting apparatus 100 will be first explained.

In FIG. 2, a segmentation section 101 divides information bit data, which is to be transmitted to the receiving apparatus 150, into a plurality of blocks, and outputs block information bit data to an error detection data adding section 102.

The error detection data adding section 102 adds check data for error detection to block information bit data, and outputs information bit data with added check data to a coding section 103.

The coding section 103 error correction codes information bit data with added check data using a turbo code, and divides it into F frame data to output to a number adding section 104.

The number adding section 104 adds block numbers (1, 2, . . . n) and frame numbers (1, 2, . . . , F) to F frame data output from the coding section 103. Namely, when first block information bit data segmented by the segmentation section 101 is framed by the coding section 103, numbers of 1-1, 1-2, . . . , 1-F are added to frame data. When second block information bit data is framed, numbers of 2-1, 2-2, . . . 2-F are added to the frame data. The frame data to which the block numbers and frame numbers are added is output to a storing section 105.

The storing section 105 stores frame data output from the number adding section 104. Moreover, the storing section 105 reads stored frame data and outputs read data to an interleaver 108 based on control of a control section 106.

The control section 106 manages frame data stored in the storing section 105 based on a receipt acknowledgment signal (hereinafter referred to as ACK) or a repeat request signal (hereinafter referred to as NACK) sent from the receiving apparatus 150. In other words, when a signal sent from a communication partner is ACK, the control section 106 controls the storing section 105 to output frame data of a next block number to an interleaver 108. When the signal sent from the receiving apparatus 150 is NACK, the control section 106 controls the storing section 105 to output untransmitted frame data of a transmitted block number to the interleaver 108. The control section 106 manages the frame data to be transmitted in the frame data number and the number of transmissions, and controls an interleave pattern deciding section 107.

The interleave deciding section 107 decides an interleave pattern based on control of the control section 106. Particularly, at the time of retransmitting the same frame data, the interleave deciding section 107 decides an interleave pattern to equalize the frequency with which the respective interleave patterns are applied. The decided interleave pattern is sent to the interleaver 108. In addition, an interleave pattern deciding method will be described later.

The interleaver 108 interleaves frame data read from the storing section 105 with an interleave pattern decided by the interleave pattern deciding section 107, and outputs interleaved frame data to a modulating section 109. The modulating section 109 modulates a signal output from the interleaver 108 and outputs it to a transmitting section 110. The transmitting section 110 provides a predetermined radio transmission processing (D/A conversion, upconvert, and the like) to the modulated frame data, and transmits it to the receiving apparatus 150 via an antenna 111.

Additionally, the interleaver 108, the modulating section 109 and the transmitting section 110 function as transmitting means.

The configuration of the receiving apparatus 150 will be next explained. Frame data transmitted from the transmitting apparatus 100 is received by a receiving section 152 via an antenna 151.

The receiving section 152 provides a predetermined radio reception processing (downconvert, A/D conversion, and the like) to the received frame data, and outputs it to the processed signal to a demodulating section 153. The demodulating section 153 demodulates frame data output from the receiving section 152, and outputs it to a deinterleaver 154.

The deinterleaver 154 deinterleaves the demodulated frame data with the interleave pattern used in the transmitting apparatus 100 based on control of a control section 159, and returns it to uninterleaved frame data. The deinterleaved frame data is output to a number extracting section 155.

The number extracting section 155 extracts a block number and a frame number of the deinterleaved frame data and outputs the extracted number and frame data to a storing section 156.

The storing section 156 stores the number and the frame data output from the number extracting section 155 to be associated with each other. Moreover, the storing section 156 reads stored frame data and outputs the read frame data to a decoding section 157.

The decoding section 157 decodes the frame data output from the storing section 156 with a coding rate corresponding to the number of frames, and outputs the decoded frame data to an error detecting section 158. The error detection section 158 performs error detection using error detection data of frame data decoded by the decoding section 157. Whether or not an error is detected is informed to a control section 159.

When an error is detected by the error detecting section 158, the control section 159 performs control that transmits NACK to the transmitting apparatus 100 to request a repeat. Moreover, the control section 159 performs control that maintains frame data stored in the storing section 156. While, when an error is not detected by the error detecting section 158, the control section 159 performs control that transmits ACK to the transmitting apparatus 100 and control that erases frame data stored in the storing section 156.

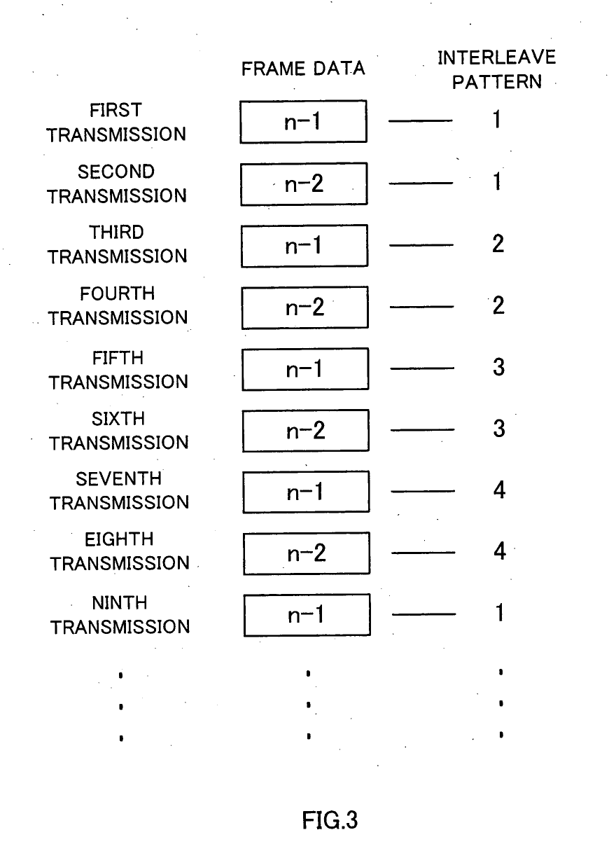

Next, the interleave pattern deciding method in the control section 106 and the interleave pattern deciding section 107 of the transmitting apparatus 100 will be explained using FIG. 3. This figure shows a corresponding relationship between each number of frame data transmitted by the transmitting apparatus 100 and each interleave pattern when the transmitting apparatus 100 continuously receives NACK. In this figure, it is assumed that a block number is n and block n is framed into two frames. It is also assumed that four kinds of interleave patterns can be used.

The control section 106 manages the frame number and the number of transmissions, and controls the interleave pattern deciding section 107 to decide an interleave pattern based on the management. The interleave pattern deciding section 107 first decides that interleave pattern 1 is applied to frame data n-1 of block n based on control of the control section 106.

Next, when the control section 106 receives NACK indicating a repeat request from the receiving apparatus 150 that received frame data n-1, the control section 106 controls the interleave pattern deciding section 107 to apply interleave pattern 1 to untransmitted frame data n-2 of block n. The interleave pattern deciding section 107 decides an interleave pattern 1 based on control of the control section 106.

Moreover, when the control section 106 receives NACK again, the control section 106 controls the interleave pattern deciding section 107 to apply interleave pattern 2 to transmitted frame data n-1 since there is no untransmitted frame data of block n. Afterward, when the control section 106 continuously receives NACK, the control section 106 repeats the aforementioned operation as illustrated in FIG. 3. In the example of FIG. 3, the transmission is performed with the first transmitted interleave pattern transmitted at the ninth transmission. This operation is performed until the control section 106 receives ACK.

When such an interleave pattern decision is performed, regarding frame data n-1 and n-2 up to the eighth transmission, it is understood that interleave patterns 1 to 4 are equally used.

According to this embodiment, when the transmitting apparatus continuously receives NACK and retransmits the same frame data repeatedly, the interleave pattern is decided to equalize the frequency with which the plurality of interleave patterns are applied. This makes it possible to equalize likelihood of a signal input to a decoding section and improve the error correction ability of the receiving apparatus. As a result, the number of retransmissions can be reduced.

In addition, the present embodiment explained the example in which the interleave patterns 1 to 4 were used in order according to the number of transmissions. However, the present invention is not limited to this, and any combination of the order of interleave patterns 1 to 4 to be used may be possible.

Moreover, the present embodiment explained that the number of frames per one block was 2 and the number of interleave patterns was 4. However, the present invention is not limited to this. It is assumed that the number of frames per one block and the number of interleave patterns are arbitrarily set.

(Embodiment 2)

This embodiment will explain a case in which a mapping pattern is used as the transmission pattern.

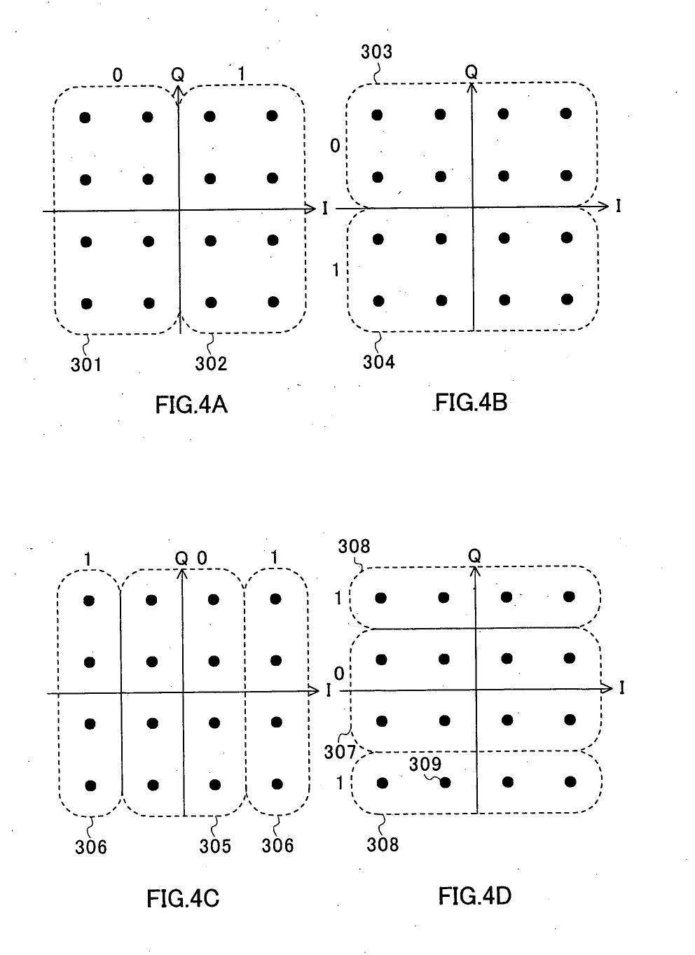

Here, the mapping pattern is explained. FIG. 4A to FIG. 4D are views explaining an order of mapping one signal point of 16 QAM. FIG. 4A illustrates signal points that are selectable based on a first bit of four-bit transmission data. More specifically, when a first bit is “0”, a signal point is selected from signal points of second and third (area 301) quadrants on an IQ plane. On the other hand, when the first bit is “1”, a signal point is selected from signal points of first and fourth (area 302) quadrants on the IQ plane. In this way, selection of a signal point corresponding to “0” or “1” is referred as signal point selection.

Next, FIG. 4B illustrates the signal point selection for a second bit. Signal points of the first and second (area 303) quadrants on the IQ plane correspond to “0” and signal points of the third and fourth (area 304) quadrants on the IQ plane correspond to “1.” However, the signal point selection is performed from the signal points selected at the first bit.

Similarly, FIG. 4C illustrates the signal point selection for a third bit. Signal points of an area 305 correspond to “0” and signal points of an area 306 correspond to “1.” Regarding the third bit, the signal point selection is also performed from the signal points selected up to the second bit.

FIG. 4D illustrates the signal point selection for a fourth bit. Signal points of an area 307 correspond to “0” and signal points of an area 308 correspond to “1.” At the time of performing the signal point selection of four bits on a one-bit by one-bit basis, the signal point selection for each bit is restricted by the area (signal point) selected by the one bit previous signal selection, and one signal point is decided at the time when the signal point selection for the final fourth bit is performed.

Here, a specific explanation will be given when four-bit transmission data is, for example, “0101.” Since the first bit is “0”, a signal point of the area 301 is selected from FIG. 4A.

Next, since the second bit is “1”, this is a signal point of the area 304 and a signal point of the area 301 selected at the first bit from FIG. 4B. In other words, since this is a signal point common to the area 301 and the area 304, the corresponding signal point is narrowed to the signal points of the third quadrant.

Next, since the third bit is “0”, this is a signal point of the area 305 and a signal point common to the signal point selected up to the second bit. So far, the corresponding signal point is narrowed to two signal points.

Next, since the final fourth bit is “1”, this is a signal point of the area 308 and a signal point common to two signal points selected up to the third bit. In other words, a signal point 309 is specified as a signal point of transmission data “0101”, and this signal point is finally mapped.

The above explained case in which a signal point was selected from bit data. However, conversely, bit data can be inferred from one signal point using FIG. 4A to FIG. 4D.

In this embodiment, changing the mapping pattern is to change the order of the signal point selections for the first bit to the fourth bit. In the aforementioned example, the signal point selection for the first bit is performed using FIG. 4A and the signal point selection for the second bit is performed using FIG. 4B. Similarly, the signal point selections for the third and fourth-bits are performed using FIGS. 4C and 4D, respectively. When the order of the signal point selections is changed, the signal point selection for the first bit is performed using FIG. 4B and the signal point selection for the second bit is performed using FIG. 4D. The signal point selections for the third and fourth bits are performed using FIGS. 4A and 4C, respectively. It is needless to say that the receiving apparatus demodulates using the mapping pattern that the transmitting apparatus used for modulation.

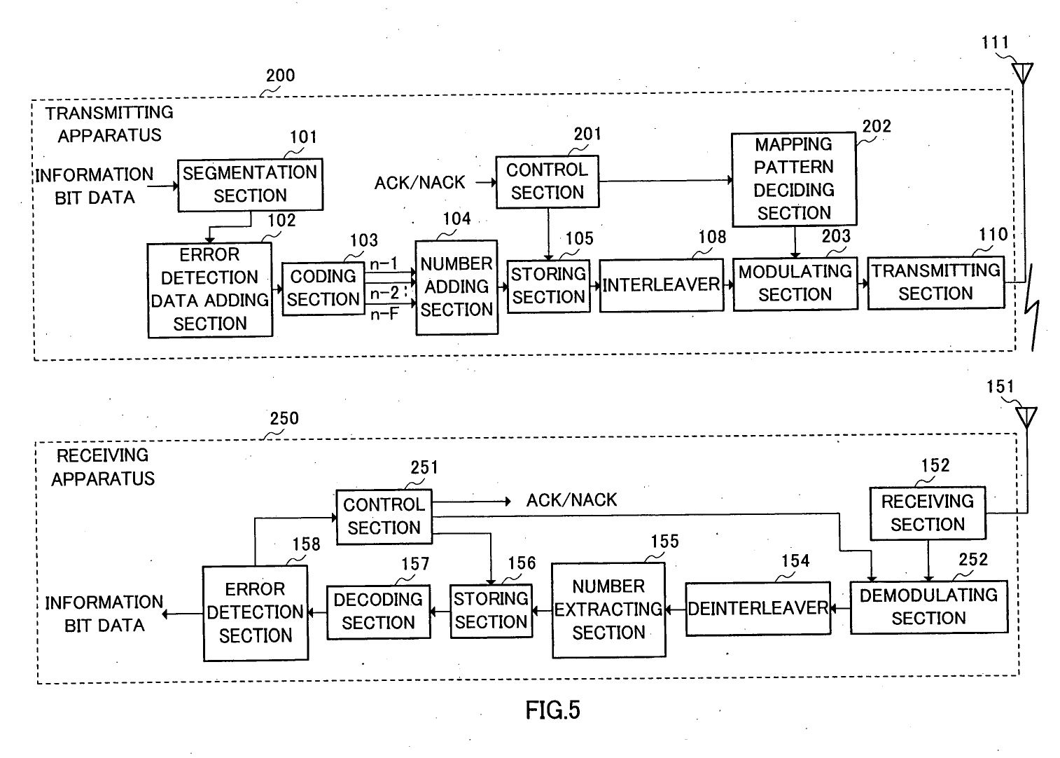

FIG. 5 is a block diagram illustrating the configuration of the transmitting apparatus and that of the receiving apparatus according to Embodiment 2. However, in this figure, parts in this figure common to those in FIG. 2 are assigned the same reference numeral as in FIG. 2 and their detailed explanations are omitted.

The configuration of a transmitting apparatus 200 is first explained. A control section 201 manages frame data stored in the storing section 105 based on ACK or NACK transmitted from a receiving apparatus 250. Namely, when a signal transmitted from the receiving apparatus 250 is AKC, the control section 201 controls frame data of a next block number to be output to the interleaver. When a signal transmitted from the receiving apparatus 250 is NAKC, the control section 201 controls untransmitted frame data of a transmitted block number to be output to the interleaver 108. Moreover, the control section 201 controls a mapping pattern deciding section 202 to decide a mapping pattern of transmitting frame data.

The mapping pattern deciding section 202 decides a mapping pattern based on control of the control section 201, and informs the decided mapping pattern to a modulating section 203. In addition, the mapping pattern deciding method will be described later.

The modulating section 203 modulates frame data interleaved by the interleaver 108 with the mapping pattern decided by the mapping pattern deciding section 208, and outputs the modulated frame data to the transmitting section 110.

The configuration of the receiving apparatus 250 is next explained. A control section 251 controls a demodulating section 252 to demodulate by the method corresponding to the mapping pattern decided by the mapping pattern deciding section 202.

The demodulating section 252 demodulates frame data transmitted from the transmitting apparatus 200 based on control of the control section 251, and outputs the demodulated frame data to the deinterleaver 154.

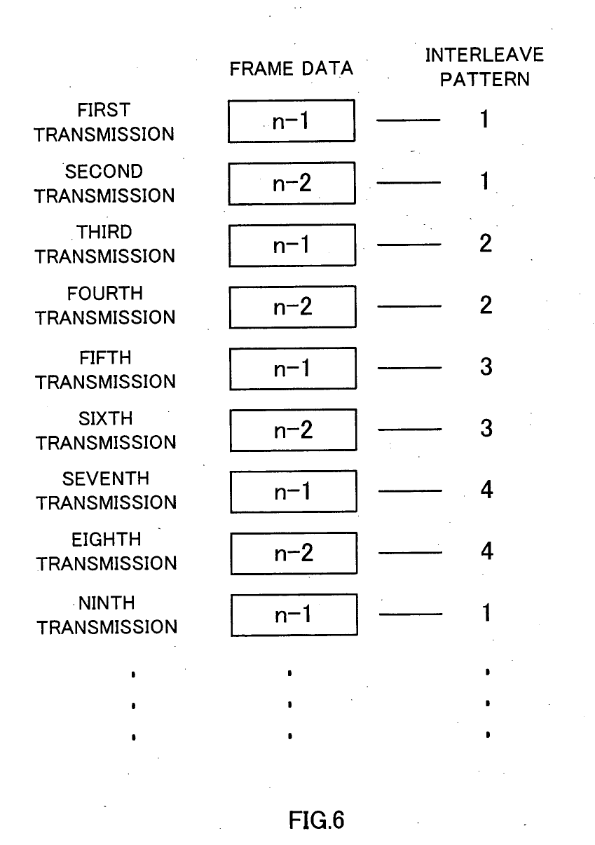

An explanation will be next given of the mapping pattern deciding method in the control section 201 and the mapping pattern deciding section 202 of the transmitting apparatus 200 using FIG. 6. This figure shows a corresponding relationship between each number of frame data transmitted by the transmitting apparatus 200 and each mapping pattern when the transmitting apparatus 200 continuously receives NACK. In this figure, it is assumed that a block number is n and block n is framed into two frames. It is also assumed that four kinds of mapping patterns can be used.

The control section 201 manages the frame data number and the number of transmissions, and controls the mapping pattern deciding section 202 to decide a mapping pattern based on the management. The mapping pattern deciding section 202 first decides that mapping pattern 1 is applied to frame data n-1 of block n based on control of the control section 201.

Next, when the control section 201 receives NACK indicating a repeat request from the receiving apparatus 250 that received frame data n-1, the control section 201 controls the mapping pattern deciding section 202 to apply mapping pattern 1 to untransmitted frame data n-2 of block n. The mapping pattern deciding section 202 decides mapping pattern 1 based on control of the control section 201.

Moreover, when the control section 201 receives NACK again, the control section 201 controls the mapping pattern deciding section 202 to apply mapping pattern 2 to transmitted frame data n-1 since there is no untransmitted frame data of block n. Afterward, when the control section 201 continuously receives NACK, the control section 201 repeats the aforementioned operation as illustrated in FIG. 6. In the example of FIG. 6, the transmission is performed with the mapping pattern transmitted first at ninth transmission. This operation is executed until the control section 201 receives ACK.

Such a mapping decision shows that mapping patterns 1 to 4 are equally used in frame data n-1 and n-2 seeing from the time up to the eighth transmission.

According to this embodiment, when the transmitting apparatus continuously receives NACK and retransmits the same frame data repeatedly, the mapping pattern is decided to equalize the frequency with which the respective mapping patterns are applied. This makes it possible to equalize likelihood of the signal input to the decoding section and improve the error correction ability of the receiving apparatus. As a result, the number of retransmissions can be reduced.

In addition, the present embodiment explained the example in which the mapping patterns 1 to 4 were used in order according to the number of transmissions. However, the present invention is not limited to this, and any combination of the order of mapping patterns 1 to 4 to be used may be possible.

Moreover, the present embodiment explained that the number of frames per one block was 2 and the number of interleave patterns was 4. However, the present invention is not limited to this. It is assumed that the number of frames per one block and the number of mapping patterns are arbitrarily set.

Moreover, the present embodiment explained that the modulation scheme was 16 QAM. However, the present invention is not limited to this, and any modulation scheme may be used.

A transmitting apparatus of the present invention is a transmitting apparatus that uses a hybrid automatic repeat request scheme that changes an interleave pattern for each retransmission to interleave information bit data to transmit, and the transmitting apparatus adopts a configuration including an interleave pattern deciding section that decides an interleave pattern to equalize the frequency with which the respective interleave patterns are applied at the time of retransmitting the same frame data, and a transmitting section that applies the interleave pattern decided by the interleave pattern deciding section to transmit frame data.

According to this configuration, at the time of retransmitting the same frame data, an interleave pattern is decided to equalize the frequency with which the respective interleave patterns are applied to transmit, thereby enabling to prevent information bit data from being transmitted with only a specific interleave pattern. This makes it possible to prevent an error from being repeatedly detected in a specific signal at the receiving side.

The transmitting apparatus of the present invention adopts a configuration further including a segmentation section that divides information bit data to be transmitted to a communication partner into a plurality of blocks, a coding section that codes information bit data segmented by the segmentation section to frame into a plurality of frames, a number adding section that adds a different frame number to each of the plurality of frames, and a control section that manages the frame number and the number of transmissions of each frame data to control the interleave pattern deciding section based on the frame number and the number of transmissions of each frame data wherein the interleave pattern deciding section decides an interleave pattern to equalize the frequency with which the respective interleave patterns are applied to each frame data based on control of the control section.

According to this configuration, the interleave pattern deciding section is controlled based on the number added to the frame and the number of transmissions, thereby making it possible to equalize the frequency with which the respective interleave patterns are applied at the time of retransmitting the same frame data.

The transmitting apparatus of the present invention adopts a configuration wherein the interleave pattern is changed to a mapping pattern.

According to this configuration, at the time of retransmitting the same frame data, a mapping pattern is decided to equalize the frequency with which the respective mapping patterns are applied to transmit, thereby enabling to prevent information bit data from being transmitted with only a specific mapping pattern. This makes it possible to prevent an error from being repeatedly detected in a specific signal at the receiving side.

A data communication system of the present invention is a data communication system that includes a transmitting apparatus using a hybrid automatic repeat request scheme that changes an interleave pattern for each retransmission to interleave information bit data to transmit and a receiving apparatus that receives a signal transmitted from the transmitting apparatus, and the transmitting apparatus adopts a configuration including an interleave pattern deciding section that decides an interleave pattern to equalize the frequency with which the respective interleave patterns are applied at the time of retransmitting the same frame data, and a transmitting section that applies the interleave pattern decided by the interleave pattern deciding section to transmit frame data, and the receiving apparatus adopts a configuration including a reception processing section that processes reception of frame data with the interleave pattern decided by the interleave pattern deciding section.

According to this configuration, at the time of retransmitting the same frame data, an interleave pattern is decided to equalize the frequency with which the respective interleave patterns are applied to transmit, thereby enabling to prevent information bit data from being transmitted with only a specific interleave pattern. This makes it possible to prevent an error from being repeatedly detected in a specific signal at the receiving side.

A transmitting method of the present invention is a transmitting method that uses a hybrid automatic repeat request scheme that changes an interleave pattern for each retransmission to interleave information bit data to transmit, the transmitting method includes the interleave pattern deciding step of deciding an interleave pattern to equalize the frequency with which the respective interleave patterns are applied at the time of retransmitting the same frame data, and the transmitting step of applying the interleave pattern decided by the interleave pattern deciding step to transmit frame data.

According to this configuration, at the time of retransmitting the same frame data, an interleave pattern is decided to equalize the frequency with which the respective interleave patterns are applied to transmit, thereby enabling to prevent information bit data from being transmitted with only a specific interleave pattern. This makes it possible to prevent an error from being repeatedly detected in a specific signal at the receiving side.

As explained above, according to the present invention, when the transmitting apparatus repeatedly receives NACK to retransmit the same frame data repeatedly, a transmission pattern is decided to equalize the frequency with which the respective transmission patterns are applied, thereby enabling to equalize likelihood of the signal input to a decoder of the receiving apparatus and improve error correction ability of the decoder. As a result, the number of retransmissions can be reduced.

This application is based on the Japanese Patent Application No. 2002-125489 filed on Apr. 26, 2002, entire content of which is expressly incorporated by reference herein.

### INDUSTRIAL APPLICABILITY

The present invention is suitable for using the transmitting apparatus and transmitting method that use a hybrid automatic repeat request scheme.

1. A transmitting apparatus that uses a hybrid automatic repeat request scheme that changes an interleave pattern for each retransmission to interleave information bit data to transmit, said transmitting apparatus comprising:
an interleave pattern deciding section that decides an interleave pattern to equalize the frequency with which the respective interleave patterns are applied at the time of retransmitting the same frame data; and
a transmitting section that applies the interleave pattern decided by said interleave pattern deciding section to transmit frame data.

2. The transmitting apparatus according to claim 1, further comprising:
a segmentation section that divides information bit data to be transmitted to a communication partner into a plurality of blocks;
a coding section that codes the information bit data segmented by said segmemtaion section to frame into a plurality of frames;
a number adding section that adds a different frame number to each of the plurality of frames; and
a control section that manages the frame number and the number of transmissions of each frame data to control said interleave pattern deciding section based on the frame number and the number of transmissions of each frame data,
wherein said interleave pattern deciding section decides an interleave pattern to equalize the frequency with which the respective interleave patterns are applied to each frame data based on control of said control section.

3. The transmitting apparatus according to claim 1, wherein the interleave pattern is changed to a mapping pattern.

4. A data communication system that comprises a transmitting apparatus using a hybrid automatic repeat request scheme that changes an interleave pattern for each retransmission to interleave information bit data to transmit and a receiving apparatus that receives a signal transmitted from said transmitting apparatus,
said transmitting apparatus comprising:
an interleave pattern deciding section that decides an interleave pattern to equalize the frequency with which the respective interleave patterns are applied at the time of retransmitting the same frame data; and
a transmitting section that applies the interleave pattern decided by said interleave pattern deciding section to transmit frame data, and
said receiving apparatus comprising:
a reception processing section that processes reception of frame data with the interleave pattern decided by said interleave pattern deciding section.

5. A transmitting method that uses a hybrid automatic repeat request scheme that changes an interleave pattern for each retransmission to interleave information bit data to transmit, said transmitting method comprising:
a interleave pattern deciding step of deciding an interleave pattern to equalize the frequency with which the respective interleave patterns are applied at the time of retransmitting the same frame data; and
a transmitting step of applying the interleave pattern decided by said interleave pattern deciding step to transmit frame data.
